(19) United States
(12) Patent Application Publication
(10) Pub. No.: US 2014/0218613 A1
(43) Pub. Date: Aug. 7, 2014

(54) METHOD AND APPARATUS FOR MOTION ESTIMATION IN VIDEO IMAGE DATA

(71) Applicant: Zoran Zivkovic, Hertogenbosch (NL)

(72) Inventor: Zoran Zivkovic, Hertogenbosch (NL)

(21) Appl. No.: 14/232,330

(22) PCT Filed: Jul. 13, 2012
(86) PCT No.: PCT/EP2012/063810

§ 371 Date: Mar. 27, 2014

(30) Foreign Application Priority Data
Jul. 13, 2011 (EP) 11173856.3

(51) Int. Cl. H04N 5/14; H04N 7/01

(52) U.S. Cl. CPC H04N 5/145; H04N 7/014
USPC 348/699

(57) ABSTRACT

A method for motion estimation in video image data comprises a step of providing a block of pixels (B(F(t))) of a current image (F(t)) and a block of pixels (B(F(t−1))) of a previous image (F(t−1)) and a block of pixels (B(F(t−2))) of a pre-previous image (F(t−2)). A reconstructed block of pixels (B*(F(t), F(t−2),v)) is determined by combining the block of pixels of the previous image (B(F(t−1),v) and the block of pixels of the pre-previous image B(F(t−2),v)). A motion vector (v) of the block of pixels of the current image (B(F(t))) is evaluated by comparing the block of pixels of the current image (B(F(t))) with the reconstructed block of pixels (B*(F(t), F(t−2),v)).

### TECHNICAL FIELD

The present invention applies to the field of video processing, and display technology.

### BACKGROUND

Motion estimation is an essential part of most video systems. Estimated motion between parts of frames of a video is used for many different ways of improving the picture quality on the display: frame rate conversion for reducing motion blur and motion judder; motion compensated reduction of interlacing artifacts, i.e. de-interlacing; motion compensated noise reduction; super resolution etc. All such video enhancement operations depend highly on the accuracy of the estimated motion.

Video images may often not be properly spatially sampled and contain alias. Interlaced material is the common use case where the signal is not properly sampled in the vertical direction. Non-proper down sampled images may also occur in a video processing system where certain pixels are removed, and images down-sampled, to limit the memory bandwidth and computation costs. Motion estimation is based on comparing pixel values from at least two images and finding the best match. If the images are not be properly spatially sampled and contain alias this will influence the comparison between the images and lead to inaccurate motion estimation.

It may be desirable to provide a method for motion estimation in video image data in which the influence of aliasing effects to the motion estimation is reduced. It is a further concern to provide an apparatus for establishing motion estimation in video image data and a device for storing a program code to establish motion estimation, wherein the influence of aliasing effects to the motion estimation is reduced.

### SUMMARY

An embodiment of a method for motion estimation in video image data is specified in claim 1. The method for motion estimation in video image data may comprise the steps of:
providing a block of pixels of a current image and a block of pixels of a previous image and a block of pixels of a pre-previous image,
determining a reconstructed block of pixels by combining the block of pixels of the previous image and the block of pixels of the pre-previous image,
evaluating a motion vector of the block of pixels of the current image by comparing the block of pixels of the current image with the reconstructed block of pixels.

An embodiment of an apparatus for establishing motion estimation in video image data is specified in claim 10 and a device for storing a program code to establish motion estimation is specified in claim 11.

It is to be understood that both the foregoing general description and the following detailed description present embodiments and are intended to provide an overview or a framework for understanding the nature and character of the disclosure. The accompanying drawings are included to provide a further understanding, and are incorporated into and constitute a part of this specification. The drawings illustrate various embodiments and, together with the description, serve to explain the principles and operation of the concepts disclosed.

### BRIEF DESCRIPTION OF THE DRAWINGS

Embodiments of the invention are illustrated by non-limiting examples in the figures of the accompanying drawings, in which:

FIG. 1 shows image blocks in different frames,

FIG. 2 shows an embodiment of a method for motion estimation,

FIG. 3 shows another embodiment of a method for motion estimation,

FIG. 4 shows a vertical motion estimation of interlaced video data with full pixel precision,

FIG. 5 shows a vertical motion estimation of interlaced video data with half pixel precision,

FIG. 6 shows an example of an interlaced video motion estimation,

FIG. 7 shows another example of an interlaced video motion estimation.

### DETAILED DESCRIPTION

A solution is proposed for accurate comparison of pixel data between images of a video that is non-properly spatially sampled, e.g. interlaced video. The accurate comparison can be used for accurate motion estimation on the non-properly spatially sampled video.

For a set of pixels, or a single pixel, form the one video frame, e.g. the current field of an interlaced video, the solution combines a set of previous or upcoming frames, e.g. the previous and pre previous field of the interlaced video, to accurately reconstruct the signal corresponding to the pixels from the initial frame, e.g. the current field. The best motion vector is selected based on some comparison between the set of pixel from the initial frame and the reconstructed signal.

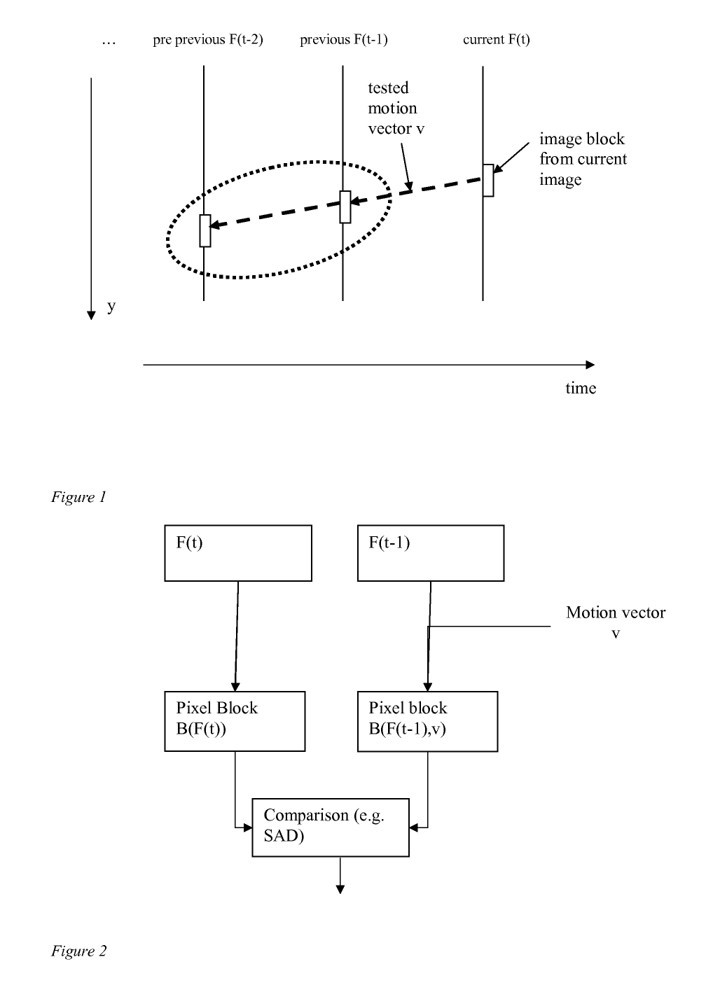

FIG. 1 is explaining the general idea. Let current, previous and pre-previous images be denoted as F(t),F(t−1) and F(t−2).

It is assumed that the three video images are not properly sampled and contain alias. Let the set of pixels, e.g. an image block, from the current image be denoted as B(F(t)). The image block may be configured as a rectangular image block. In order to evaluate a motion vector v a typical motion estimation technique compares the image pixels from the current frame F(t) and the previous images F(t−1) that contains alias. FIG. 2 presents a block diagram of this standard approach to determine the reliability of a motion vector v. Let the block along the vector v in the previous image be denoted as B(F(t−1),v). The comparison, e.g. sum of absolute differences between the pixel values, is denoted as:

Compare(B(F(t)), B(F(t−1),v)) (1)

The result of the comparison is usually a value where, for example the lowest value corresponds to the best match between the sets of pixels B(F(t)) and B(F(t−1),v). For accurate motion estimation it is required that for the correct motion vector v the comparison is expected to indicate that this is the best match. Since the images contain alias this will not be the case and the comparison might indicate poor match even for the correct vector v. This gives poor quality motion estimation results.

Our solution combines the image pixels of multiple frames to properly reconstruct the samples corresponding to the current image pixels and remove the influence of the alias on the pixel comparison. Let a block of pixels along the vector v or corresponding to vector v in the previous image be denoted as B(F(t−1),v), a block of pixels along the vector v or corresponding to vector v in the pre-previous image be denoted as B(F(t−2),v) and the block of pixels in the current image be denoted as B(F(t)), see FIG. 1. The previous and the pre-previous blocks are combined to reconstruct the samples corresponding set of pixels denoted as, B*(F(t), F(t−2),v). More images and blocks can also be used. The reconstructed block of pixels B*(F(t), F(t−2),v) is used for comparison in (1) and the comparison becomes:

Compare(B(F(t)), B*(F(t), F(t−2),v)) (2)

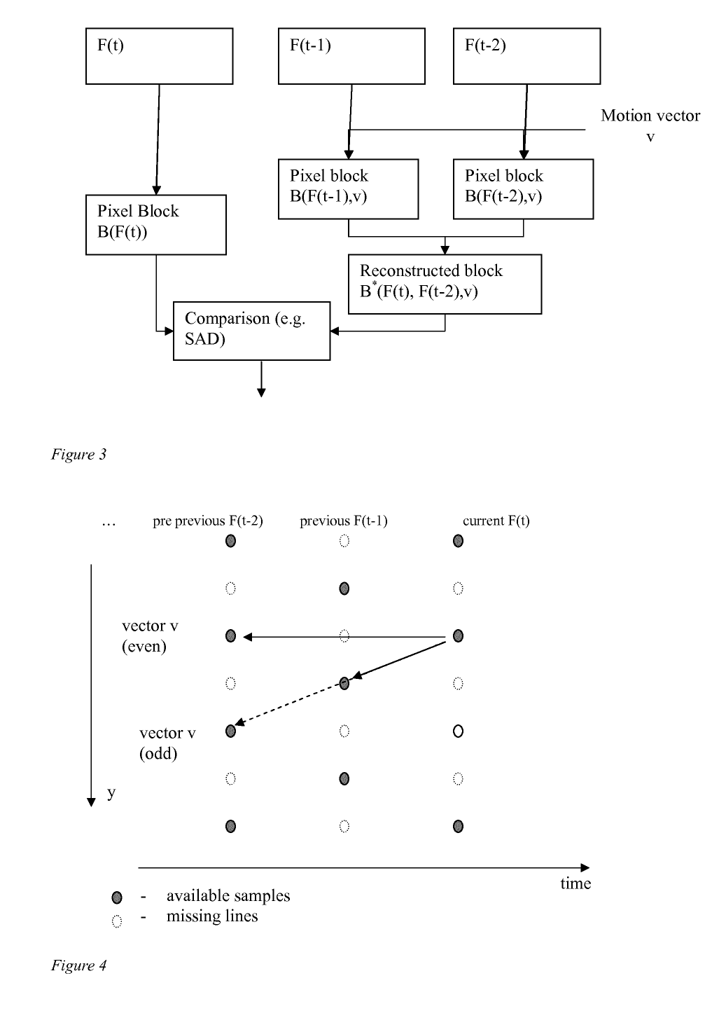

In this way the comparison will not be influenced by the different alias components in the images, if the reconstruction from the multiple frames, e.g. B*(F(t), F(t−2),v), is done properly. See FIG. 3 for example of a block diagram of this improved approach to determine the reliability of a motion vector v. Sampling and motion should allow this proper reconstruction which is usually the case for interlaced video data as described later. The reconstruction of the pixels from the multiple images, e.g. B*(F(t), F(t−2),v), can be any method that reduces the influence of the alias on the comparison (2).

The presented improved signal comparison can be part of any motion estimation framework. Embodiment and experiments performed were using the common motion estimation framework [1] such as is described in: U.S. Pat. No. 6,278,736, Motion estimation, Gerard De Haan et al., Philips, Aug 21, 2001.

The solution is demonstrated to give much more accurate vectors for interlaced video data and the quality of the motion compensated de-interlacing results can be greatly improved. The solution is relevant for any other motion compensated video processing technique (frame rate conversion, temporal super resolution) in cases when the signal is not properly sampled spatially.

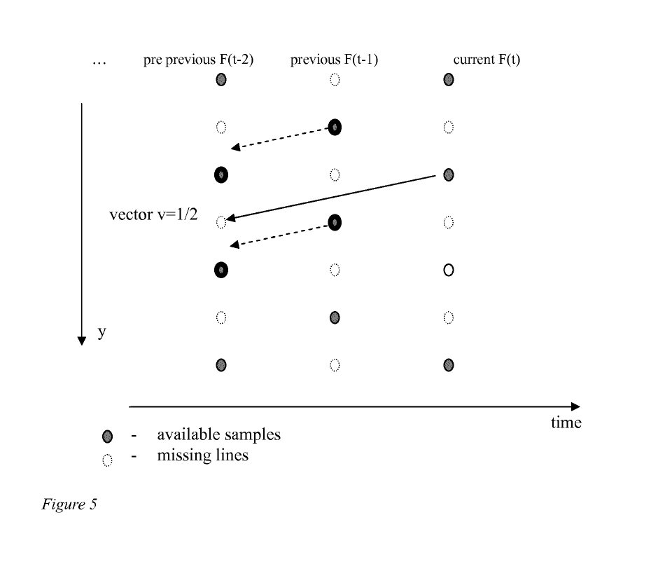

In the following an embodiment for the interlaced video—full pixel—will be presented. FIG. 4 presents an illustration of the interlaced video data where vertical motion is estimated with full pixel precision, i.e. full-pixel in the de-interlaced frame and half pixel on the interlaced video fields.

Comparing pixels (for the motion estimation) between current field/image F(t) and previous field/image F(t−1) will lead into problems for even pixels vertical displacements ( . . . −2, 0, 2, . . . ) since there are pixels missing in the previous field at those locations. Interpolating these pixel values from the available pixels would be influenced by the alias and lead to non accurate motion vectors.

FIG. 4 illustrates that if we consider the pre-previous field/image F(t-2) we can do proper comparison and always compare available pixels. In this case for the odd amount of pixels vertical displacements ( . . . , −3, −1, 1, 3, . . . ) we can choose either pixels from the previous field F(t−1) or the pre previous field F(t−2). Using the previous field F(t−1) pixels would give faster response to acceleration in image sequence but the pre-previous filed F(t−2) is easier for implementation and preferred.

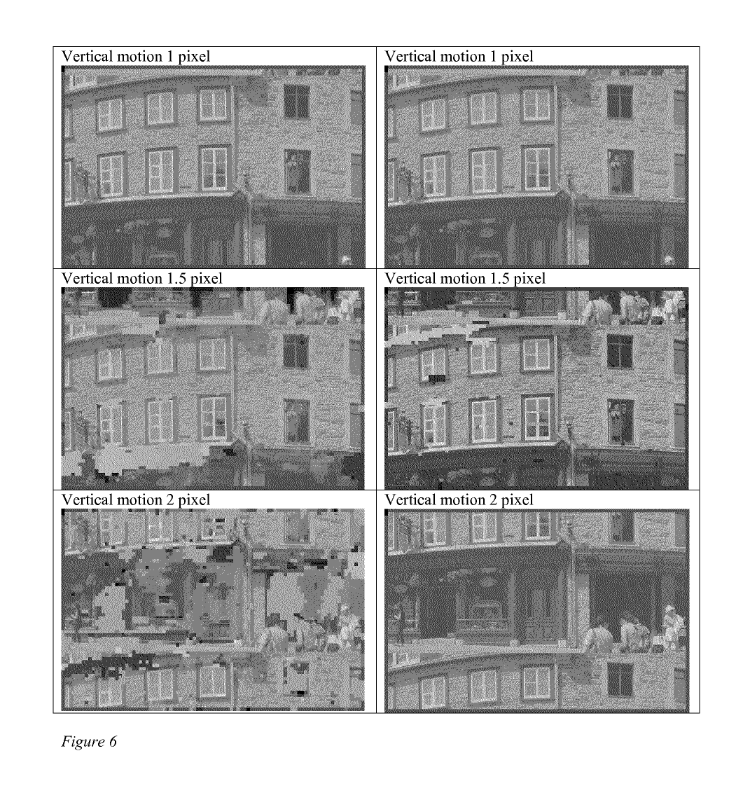

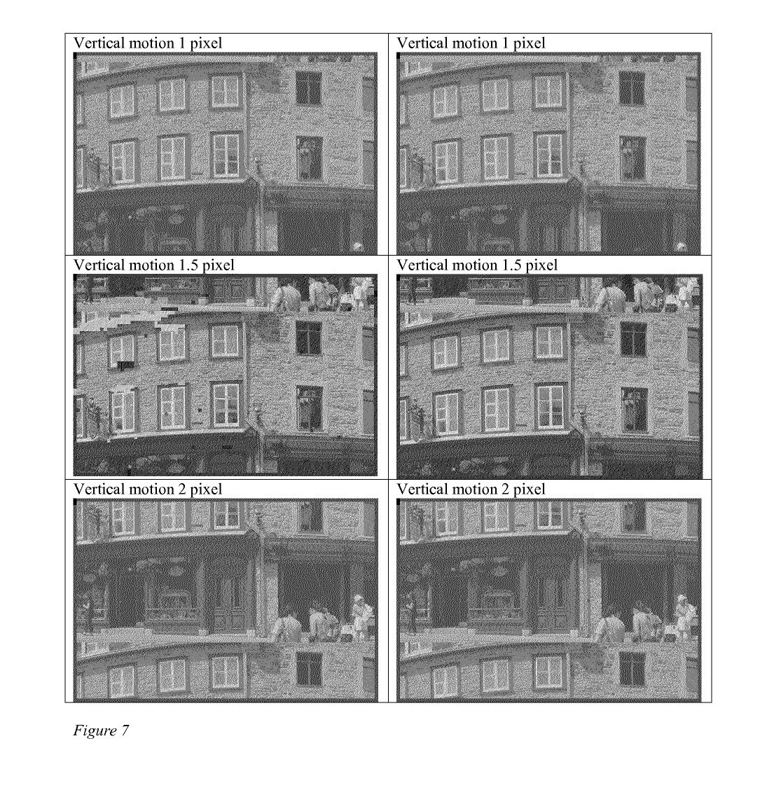

Examples for the interlaced video motion estimation are presented in FIG. 6. The images in the left column relate to motion estimation using current field and previous field (standard approach influenced by the alias). The images in the right column relate to motion estimation using current and previous and pre-previous fields (full-pixel embodiment).The overlay colors represent the estimated motion vectors. The scene has uniform vertical motion and the correct result should be uniform color. It can be seen that the standard solution estimating between current and previous field results in a noisy vector field because of the alias. The solution for the full-pixel movements described here improves the results for the full pixel movements, top and bottom right images. For the 1.5 pixel movement, middle image on the right, we used linear interpolation is used and noisy vectors can be observed that degrade the picture quality. Embodiment solving the sub-pixel movements is described below.

In the following an embodiment for the interlaced video—sub-pixel—is described. Example for the interlaced video data where vertical motion is estimated with ½ pixel precision is presented in FIG. 5. For the full pixel vectors the solution in the previous embodiment can be used.

For the vectors in between pixels, e.g. ½ pixels as in FIG. 5, there are no directly available pixels and the pixel values need to be properly interpolated, for example, including the corresponding pixels from the previous field as indicated in FIG. 5.

The reconstruction of the pixels from multiple fields/images, e.g. B*(F(t), F(t−2),v), can be any technique that reduces the influence of the alias. In our implementation we used optimal linear filter where optimal means that the coefficients of the filter are chosen such that they are optimal in reducing the influence of the alias on the comparison between the block of pixels B(F(t)) of an initial image F(t) and the reconstructed block of pixels B*(F(t), F(t−2),v). The optimal linear filter presents a linear combination of the neighboring pixels from the two image fields, for example, the four pixels close to the vector v indicated by the bold circles in FIG. 5.

The filter coefficients were estimated from a set of progressive videos where the accurate motion vectors were known. The videos are sub-sampled vertically in such a way to simulate the interlaced video. The filter coefficients are estimated such to minimize the influence of the alias on the resulting comparison value for the correct known motion vectors. In our case the comparison value was the sum of absolute pixel differences.

For interlaced video content the alias is only present in the vertical direction. Therefore it is possible to use a standard interpolation filter for the horizontal direction, for example linear interpolation filter. The linear reconstruction filter is then optimized only for the vertical direction, i.e. the vertical dimension of the image, to reduce the influence of the alias.

FIG. 7 shows images in the left column which relate to motion estimation using current an pre-previous frames (full pixel embodiment). The images in the right column relate to motion estimation using current and previous and pre-previous frames with alias reduction reconstruction (sub-pixel embodiment). The result shown in FIG. 7 demonstrates that the influence of the alias is removed also for the sub pixel motion. The overlay colors represent the estimated motion vectors. The scene has uniform vertical motion. The proposed reconstruction based solution further reduces the influence of the alias and improves over the first embodiment that improves only the full pixel movements.

In the following an embodiment for reducing the memory bandwidth for progressive video by sub-sampling will be described. Typical memory bandwidth needed for a motion estimator corresponds to reading 2 full image frames. If the images are sub-sampled, for example by reading every second pixel, the memory bandwidth and the computation costs can be reduced but the images will contain alias and this will reduce the accuracy of the motion estimation.

A solution is to use a number of such sub-sampled images and then apply the presented method for reconstructing the signals to reduce the influence of the alias.

An example embodiment for progressive images is to read every second pixel in both x and y direction. If we read 3 frames, this gives 3*¼ frames to read which is much less than the 2 frames in the standard case. If one of the sub sampled images contains odd position pixels in both directions and the other one even ones, then the same methods as described in the previous embodiments can be used to reconstruct the signal and remove the influence of the alias during motion estimation.

Alternate implementations may also be included within the scope of the disclosure. In these alternate implementations, functions may be executed out of order from that shown or discussed, including substantially concurrently or in reverse order, depending on the functionality involved. The foregoing description has been presented for purposes of illustration and description. It is not intended to be exhaustive or to limit the disclosure to the precise forms disclosed. Obvious modifications or variations are possible in light of the above teachings. The implementations discussed, however, were chosen and described to illustrate the principles of the disclosure and its practical application to thereby enable one of ordinary skill in the art to utilize the disclosure in various implementations and with various modifications as are suited to the particular use contemplated. All such modifications and variation are within the scope of the disclosure as determined by the appended claims when interpreted in accordance with the breadth to which they are fairly and legally entitled.

1. A method for motion estimation in video image data, comprising the steps of:
providing a block of pixels of a current image and a block of pixels of a previous image and a block of pixels of a pre-previous image,
determining a reconstructed block of pixels by combining the block of pixels of the previous image and the block of pixels of the pre-previous image, and
evaluating a motion vector of the block of pixels of the current image by comparing the block of pixels of the current image with the reconstructed block of pixels.

2. The method as claimed in claim 1 wherein the block of pixels of the current image and the previous image and the pre-previous image have a rectangular shape.

3. The method as claimed in claim 1 wherein the block of pixels of the current image is compared with the reconstructed block of pixels by evaluating absolute differences between pixel values of the block of pixels of the current image and pixel values of the reconstructed block of pixels.

4. The method as claimed in claim 1 wherein at least two block of pixels of at least two previous images are combined to determine the reconstructed block of pixels.

5. The method as claimed in claim 1 wherein the reconstructed block of pixels is determined by reducing an influence of alias on the comparison between the block of pixels of the current image and the reconstructed block of pixels.

6. The method as claimed in claim 1 wherein the reconstructed block of pixels is determined by applying a linear filter to the block of pixels of the previous image and the block of pixels of the pre-previous image.

7. The method as claimed in claim 1 wherein the reconstructed block of pixels is determined by a linear combination of neighboring pixels from the previous image and the pre-previous image.

8. The method as claimed in claim 1 Wherein a linear reconstruction filter is applied for a direction in the block of pixels of the previous and the pre-previous image to determine the reconstructed block of pixels, wherein an interpolation filter is applied for another direction in the block of pixels of the previous and the pre-previous image.

9. The method as claimed in claim 1 wherein an amount of pixels less than the number of pixels included in each block of pixels of the previous and pre-previous images is used to determine the reconstructed block of pixels.

10. An apparatus for establishing motion estimation in video image data, comprising:
means for providing a block of pixels of a current image and a block of pixels of a previous image and a block of pixels of a pre-previous image,
means for determining a reconstructed block of pixels by combining the block of pixels of the previous image and the block of pixels of the pre-previous image, and
means for evaluating a motion vector (v) of the block of pixels of the current image by comparing the block of pixels of the current image with the reconstructed block of pixels.

11. A non-transitory storage medium for storing a computer executable program code to establish motion estimation, said program code being configured to implement a method for motion estimation in video image data, said method comprising:
providing a block of pixels of a current image and a block of pixels of a previous image and a block of pixels of a pre-previous image,
determining a reconstructed block of pixels by combining the block of pixels of the previous image and the block of pixels of the pre-previous image, and
evaluating a motion vector of the block of pixels of the current image by comparing the block of pixels of the current image with the reconstructed block of pixels.
